(19) United States
(12) Patent Application Publication
(10) Pub. No.: US 2026/0370164 A1
(43) Pub. Date: Nov. 19, 2026

(54) APPARATUS AND METHOD FOR CREATING SPIN ART

(71) Applicant: Christopher John Morin, San Francisco, CA (US)

(72) Inventor: Christopher John Morin, San Francisco, CA (US)

(21) Appl. No.: 19/679,485

(22) Filed: May 15, 2026

Related U.S. Application Data
(60) Provisional application No. 63/806,626, filed on May 15, 2025.

(51) Int. Cl. H02P 8/20; B44D 2/00

(52) U.S. Cl. CPC H02P 8/20; B44D 2/00

(57) ABSTRACT

An apparatus for creating spin art may include a main housing, a processor, a memory communicatively coupled with the processor, a stepper motor operably coupled with the processor, a platter engaged with the stepper motor, and a user interface operably coupled with the processor. The user interface may have a plurality of spin options selectable and deselectable therefrom. The processor may perform a plurality of operations including, in response to a spin option being selected, executing a spin program corresponding to the selected spin option. During execution of a clockwise spin program and a counterclockwise spin program, the platter may be spun continuously. During execution of a shuffle clockwise spin program and a shuffle counterclockwise spin program, the platter may be cyclically spun and stopped. During execution of a jitter spin program, the platter may be alternatingly spun in the clockwise direction and the counterclockwise direction.

### RELATED APPLICATIONS

This application claims the benefit of U.S. Provisional Application No. 63/806,626 filed May 15, 2025, the content of which is incorporated by this reference in its entirety for all purposes as if fully set forth herein.

### TECHNICAL FIELD

The disclosure herein relates generally to products and methods for making spin art.

### BACKGROUND

Conventional spin art products and methods for making spin art tend to involve a uni-directional motor spinning in one direction to achieve an outward, or radial, bleed effect. Conventional spin art devices and methods tend to lack the ability to achieve a lateral bleed effect, which generally requires an inertial effect that can occur when a liquid pools during a rest period of a stuttered or alternated spin. Users of conventional spin art devices and methods tend to lack the ability to effectively implement rest periods between spins, as well as switch the motor spin direction, in order to cohesively implement a lateral bleed and a radial bleed of the pigment in their art.

### SUMMARY

Exemplary implementations of a spin art apparatus and method for creating spin art in accordance with the present disclosure address deficiencies of the conventional art.

### BRIEF DESCRIPTION OF THE DRAWINGS

Further advantages of the present invention may become apparent to those skilled in the art with the benefit of the following detailed description of the preferred implementations and upon reference to the accompanying drawings in which:

FIG. 1 is a perspective view of one example spin art apparatus, wherein the main housing secondary wall is shown separated from the main housing, exposing the secondary compartment;

FIG. 2 is an exploded view of the apparatus of FIG. 1;

FIG. 3 is a top view of the apparatus of FIG. 1, illustrating the clockwise direction and the counterclockwise direction about the spin axis;

FIG. 4 is a top view similar to FIG. 3, but wherein the user interface is removed to expose the secondary compartment;

FIG. 5 is a perspective view of a further example spin art apparatus, wherein the user interface is shown on a tablet communicating wirelessly with the microcontroller;

FIG. 6 is an electrical block diagram of an example spin art apparatus according to one or more implementations of the present disclosure;

FIG. 7 is a block diagram illustrating example main operations performed by the processor of an example spin art apparatus;

FIG. 8 is a block diagram illustrating example operations performed by the processor of FIG. 7 while the clockwise spin program is executed;

FIG. 9 is a block diagram illustrating example operations performed by the processor of FIG. 7 while the counterclockwise spin program is executed;

FIG. 10 is a block diagram illustrating example operations performed by the processor of FIG. 7 while the shuffle clockwise spin program is executed;

FIG. 11 is a block diagram illustrating example operations performed by the processor of FIG. 7 while the shuffle counterclockwise spin program is executed;

FIG. 12 is a block diagram illustrating example operations performed by the processor of FIG. 7 while the jitter spin program is executed;

FIG. 13 is a flow diagram illustrating one example method for creating spin art;

FIG. 14 is a flow diagram illustrating example steps included in executing the clockwise spin program of the method of FIG. 13;

FIG. 15 is a flow diagram illustrating example steps included in executing the counterclockwise spin program of the method of FIG. 13;

FIG. 16 is a flow diagram illustrating example steps included in executing the shuffle clockwise spin program of the method of FIG. 13;

FIG. 17 is a flow diagram illustrating example steps included in executing the shuffle counterclockwise spin program of the method of FIG. 13;

FIG. 18 is a flow diagram illustrating example steps included in executing the jitter spin program of the method of FIG. 13; and

FIG. 19 is a perspective view of an example spin art apparatus, illustrating a substrate element mounted to the platter with pigment applied to the substrate element.

### DETAILED DESCRIPTION OF THE PREFERRED EMBODIMENTS Referring now to the drawings, like reference numerals designate identical or corresponding features throughout the several views.

With reference to the several drawings, implementations of a spin art apparatus are shown generally at 100. The spin art apparatus 100 may also be referred to as the apparatus 100. Implementations of a method for creating spin art are shown generally at 1000. The method for creating spin art 1000 may also be referred to as the method 1000.

Anywhere a letter is used in conjunction with a reference number in the present specification and drawings, it is intended to identify a specific instance of the general case. For example, a reference number 126 generally represents a program button, while specific instances of the program button 126 may be denoted in the figures at 126a-126e. In certain implementations of the apparatus 100, each of these instances may be structurally identical to one another while in other implementations their feature sets may differ from one another.

In the present specification, unless the particular nature of a fastener is described or claimed, the term fastener may be used to denote fastening by way of adhesion, a rivet, a bolt, a screw, a nail, a nut, some combination thereof, or the like.

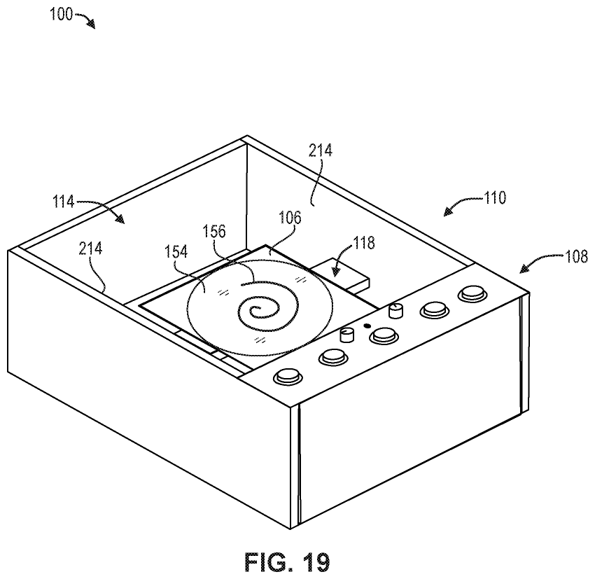

Referring to FIG. 19, in particular implementations of the spin art apparatus 100, the apparatus 100 may comprise a platter 106 configured to have a substrate element 154 mounted thereon. The platter 106 may have clips in order to facilitate the mounting of the substrate element 154. The substrate element 154 may be but is not limited to, for example, a sheet of paper, a paper board, an acrylic, or the like, for receiving pigment 156.

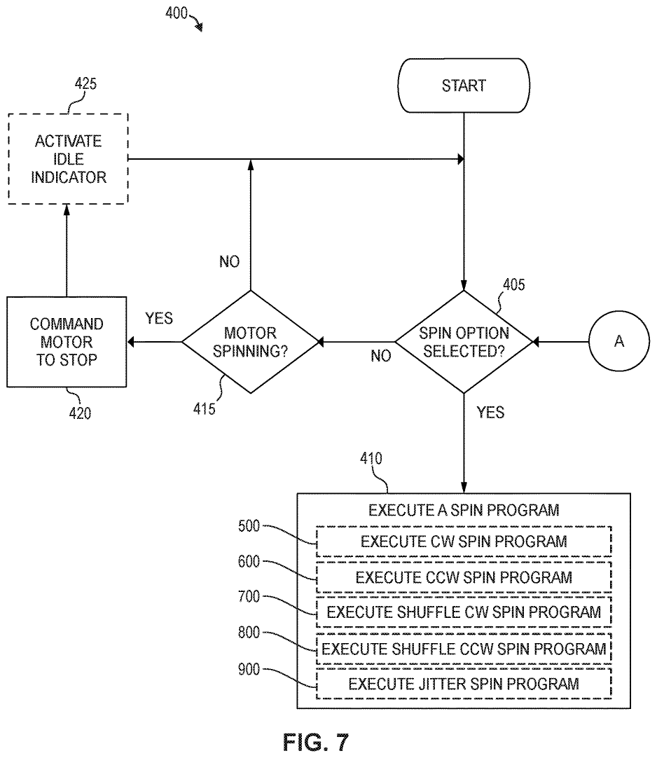

Referring to FIG. 6, the apparatus 100 may comprise a processor 300 and a stepper motor 104 operably coupled with the processor 300. The stepper motor 104 may be operably coupled with the processor 300 by way of, for example, a stepper motor controller 122. A user interface 108 may be operably coupled with the processor 300. The user interface 108 may have a plurality of spin options 304 selectable and deselectable therefrom. The user interface 108 may have a plurality of adjustable parameters 306 adjustable therefrom. An idle indicator 132 may be operably coupled with the processor 300. The apparatus may comprise a memory 302 communicatively connected to the processor 300. The memory 302 and the processor 300 may be aspects of a microcontroller 102. The processor 300 may be a CPU. The memory 302 may contain instructions that when executed by the processor 300 cause the processor 300 to perform a plurality of operations (see, for example, FIGS. 7-12). A power supply 120 may be in electrical communication with the microcontroller 102 and the stepper motor controller 122.

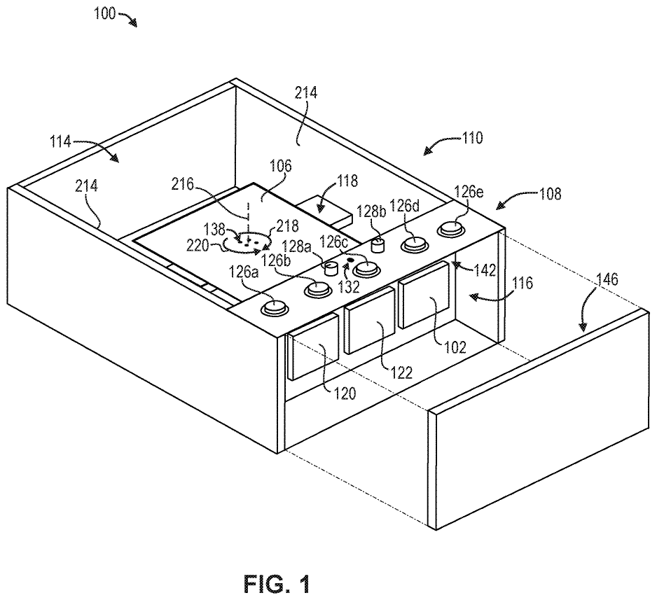

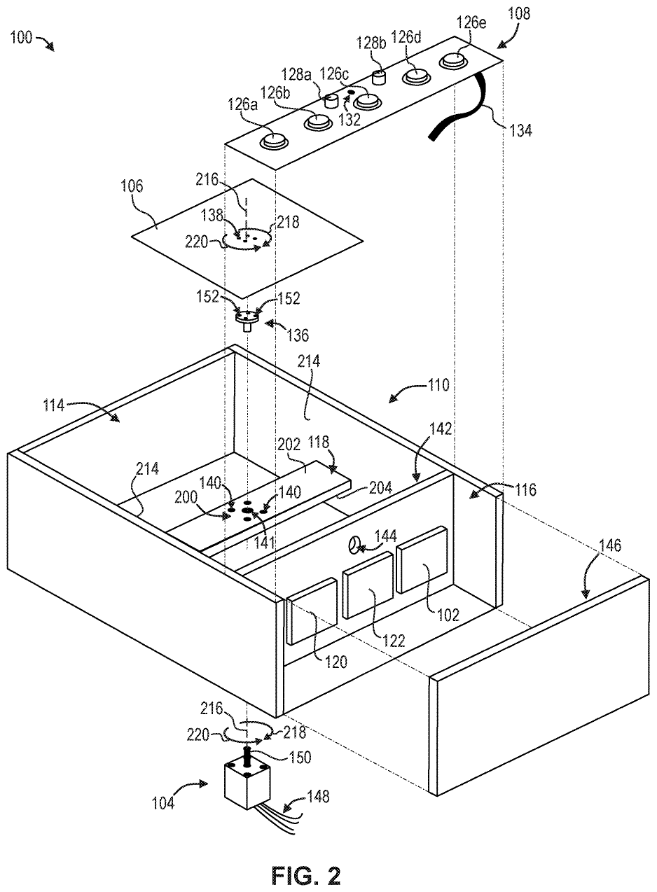

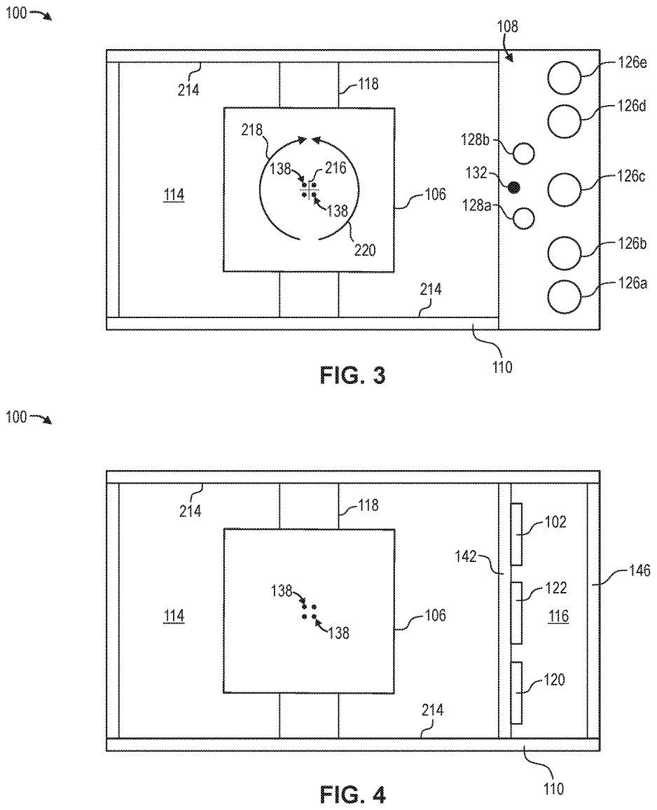

Referring to FIGS. 1-4, certain implementations of the apparatus 100 may comprise a main housing 110. A main compartment 114 may be defined within the main housing 110. The stepper motor 104 (see, for example, FIG. 2), the motor mounting portion 200, and the platter 106 may each be disposed in the main compartment 114. The apparatus 100 may comprise a motor mounting beam 118. The motor mounting beam 118 may be affixed to a pair of oppositely disposed inboard surfaces 214 of the main housing 110. The motor mounting portion 200 may be disposed on the motor mounting beam 118.

The stepper motor 104 may be engaged with the platter 106. The stepper motor 104 may be commandable to spin the platter 106 in a clockwise direction 218 about a spin axis 216 or a counterclockwise direction 220 about the spin axis 216. The stepper motor 104 may be affixed to the motor mounting portion 200, wherein, for example, the stepper motor 104 may be mounted to a lower surface 204 of the motor mounting beam 118. The platter 106 may be disposed above an upper surface 202 of the motor mounting beam 118. The engagement of the platter 106 with the stepper motor 104 may be facilitated by a spin connector element 136 extending through the motor mounting beam 118.

The spin connector element 136 may include a plurality of connector mounting apertures 152. The platter 106 may include a plurality of platter mounting apertures 138. The motor mounting beam 118 may include a plurality of motor mounting apertures 140 and a shaft receiving aperture 141 each extending through the motor mounting portion 200. The stepper motor 104 may be fastened to the motor mounting beam by way of, for example, a plurality of fasteners each extending through the motor mounting apertures 140 and engaged with the stepper motor 104. The stepper motor shaft 150 may extend through the shaft receiving aperture 141. The spin connector element 136 may be affixed to the stepper motor shaft 150. The platter 106 may be affixed to the spin connector element 136 by way of, for example, a plurality of fasteners each extending through the platter mounting apertures 138 axially aligned with the connector mounting apertures 152.

Referring to FIG. 4, in certain implementations of the apparatus 100, a secondary compartment 116 may be defined within the main housing 110. A compartment dividing wall 142 may separate the main compartment 114 from the secondary compartment 116. The processor 300 and memory 302 may each be disposed in the secondary compartment 116, as elements of, for example, the microcontroller 102. The power supply 120 may be disposed in the secondary compartment 116. The stepper motor controller 122 may be disposed in the secondary compartment 116. Referring to FIG. 2, the compartment dividing wall 142 may include a main wiring aperture 144 extending therethrough. The main wiring aperture 144 may, for example, facilitate electrical communication between the stepper motor controller 122 and the stepper motor 104 Referring to FIGS. 1-3, in some implementations of the apparatus 100, the user interface 108 may be affixed to the main housing 110. The user interface 108 may comprise a plurality of program buttons 126. For each of the plurality of program buttons 126, a said spin option 304 may correspond thereto. In certain implementations of the apparatus 100, while the program button 126 is depressed, the corresponding spin option 304 may be selected. When the program button 126 is released, the corresponding spin option 304 may be deselected. In particular implementations of the apparatus 100, the spin option 304 may remain selected after being pressed by a user until the user manually deselects the program by way of, for example, pressing the program button 126 again, shutting off the apparatus 100, selecting another spin option 304, or some other user action at the user interface 108 to deselect the selected spin option 304. In such implementations of the apparatus 100, rather than a program button 126, the spin option 304 may be selectable and deselectable by way of, for example, a program switch rather than a program button 126. The user interface 108 may include a plurality of parameter adjustment knobs 128. The parameter adjustment knobs 128 may be adjustable to incrementally increase or decrease corresponding adjustable parameters 306. The adjustable parameters may be, for example, a rest time parameter 306a, a rotation parameter 306b, and a target motor speed 306c.

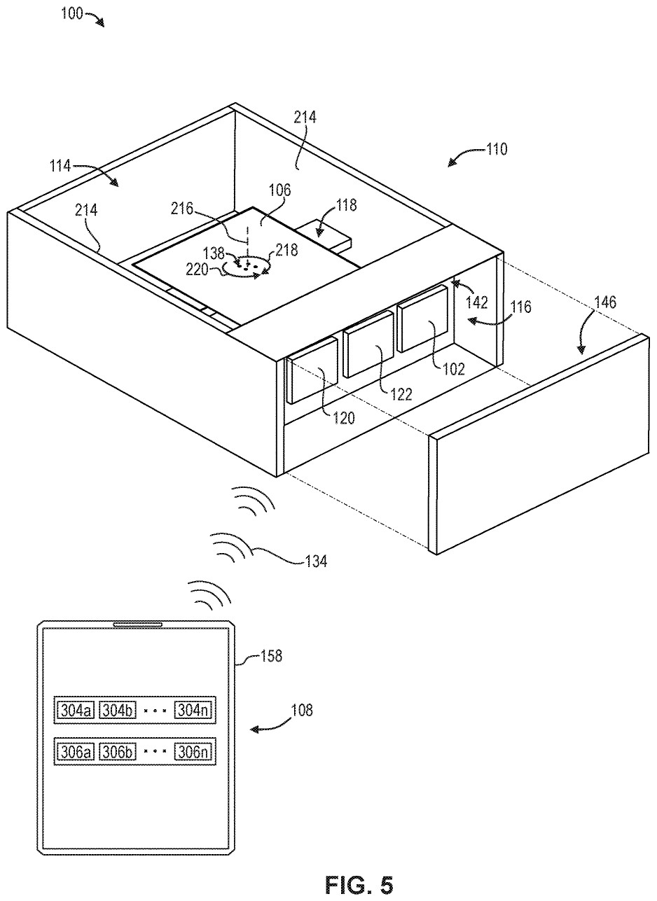

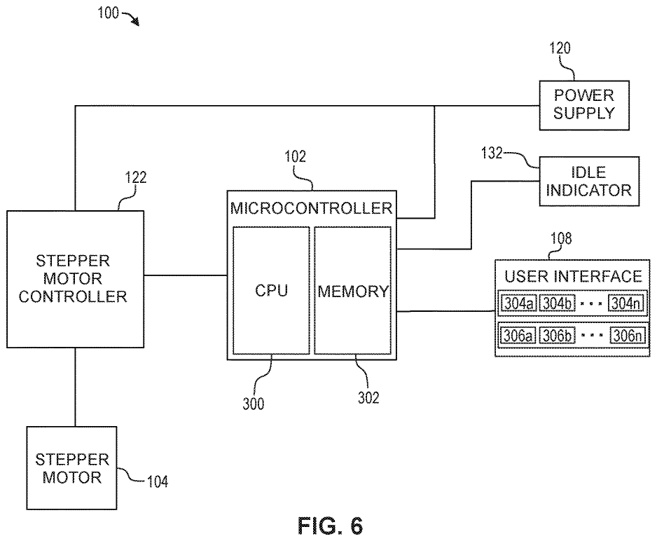

Referring to FIG. 5, in particular implementations of the apparatus 100, the user interface 108 may be configured to communicate with the processor 300 via a user interface communication element 134, such as a wireless connection. In such implementations of the apparatus 100, the user interface may be disposed on a tablet 158, phone, laptop, or similar device, wherein the spin options 304 and the adjustable parameters 306 may be selectable, deselectable, and adjustable therefrom. In certain implementations of the apparatus 100, the tablet 158, phone, laptop, or similar device, with the user interface 108 disposed thereon, may be electrically connectable and electrically deconnectable from the apparatus 100, wherein the user interface communication element 134 may be a wired connection.

Referring to FIG. 7, in response to a said spin option 304 being selected (e.g., operation 405), the processor 300 may execute a spin program in operation 410, which corresponds to the selected spin option 304. In response to the spin option being deselected (e.g., operation 405), and the stepper motor 104 is spinning (e.g., operation 415), the processor 300 may command the stepper motor 104 to stop spinning in operation 420. In some implementations of the apparatus 100, the plurality of spin options 304 may include a clockwise spin option 304a corresponding to a clockwise spin program. In operation 500, while the processor 300 executes the clockwise spin program, the platter 106 may be continuously spun in the clockwise direction 218. The plurality of spin options 304 may include a counterclockwise spin option 304b corresponding to a counterclockwise spin program. In operation 600, while the processor 300 executes the counterclockwise spin program, the platter 106 may be continuously spun in the counterclockwise direction 220.

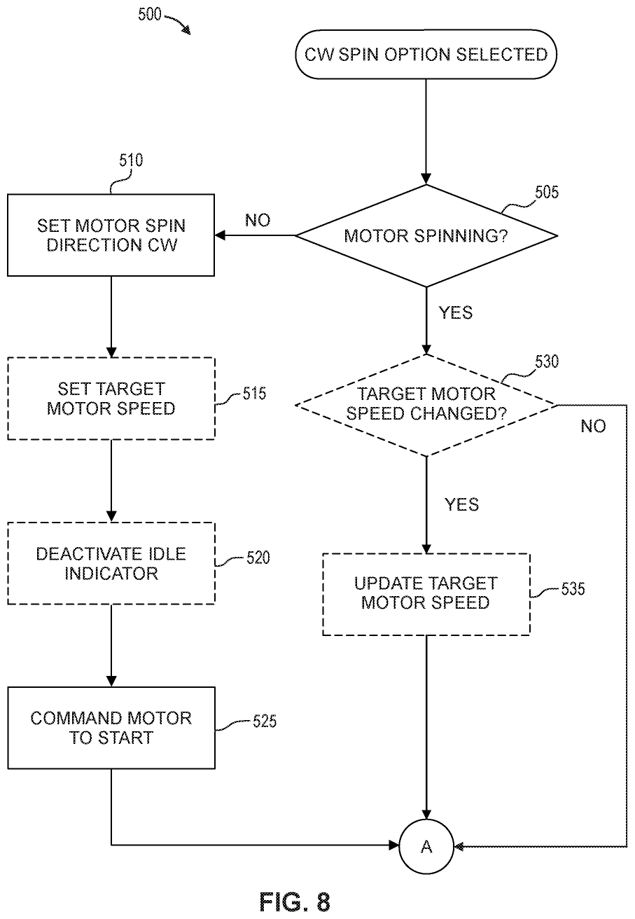

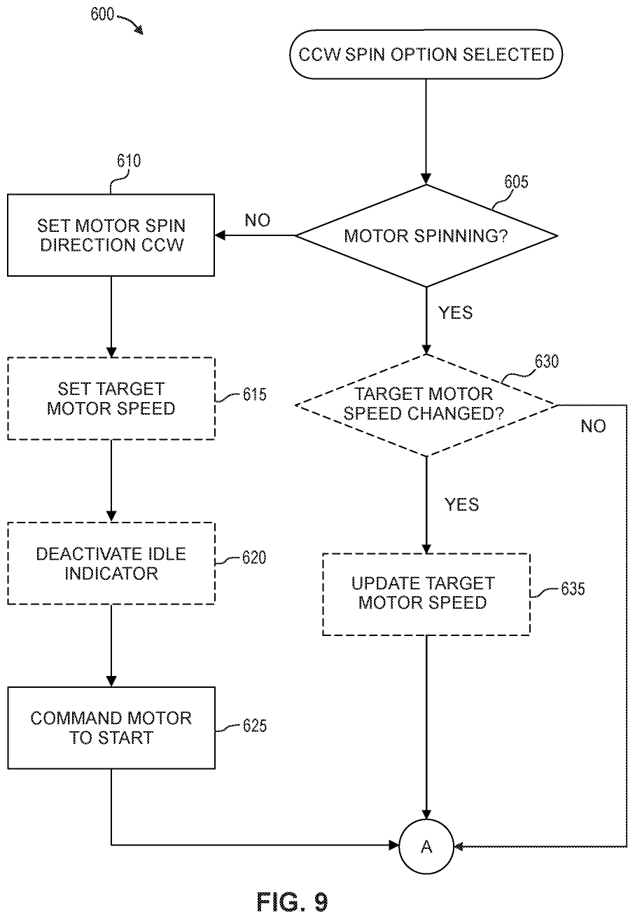

Referring to FIGS. 8 and 9, in certain implementations of the apparatus 100, executing the clockwise spin program (e.g., operation 500) and executing the counterclockwise spin program (e.g., operation 600) may comprise the processor setting the motor spin direction (e.g., operation 510, e.g., operation 610). In operation 510, the motor spin direction may be set to the clockwise direction 218. In operation 610, the motor spin direction may be set to the counterclockwise direction 220. Operation 500 and operation 600 may comprise the processor setting the target motor speed 306c (e.g., operation 515, e.g., operation 615). The target motor speed 306c may be an adjustable parameter 306 of the user interface 108. The target motor speed 306c may be an angular speed in the clockwise direction 218 or the counterclockwise direction 220. Operation 500 and operation 600 may comprise, in operation 525 and operation 625, commanding the stepper motor 104 to start spinning in the motor spin direction. The stepper motor 104 may accelerate up to the target motor speed 306c, in the set motor spin direction, and remain spinning at the target motor speed 306c until the clockwise spin option 304a or the counterclockwise spin option 304b is deselected.

In particular implementations of the apparatus 100, in operation 500 and operation 600, the target motor speed 306c may be user-selectable and user-modifiable (e.g., by way of the parameter adjustment knobs 128a) such that the target motor speed 306c can be adjusted up and/or down during the course of the execution of the program. The target motor speed 306c may change during execution of a spin program (e.g., operation 500, e.g., operation 600), for example, by way of a user adjusting the target motor speed 306c at the user interface 108 while the respective spin program is executing. The processor may determine if the stepper motor 104 is spinning or not spinning (e.g., operation 505, e.g., operation 605). If the stepper motor 104 is spinning, the processor may determine if the target motor speed 306c has been changed (e.g., operation 530, e.g., operation 630) to an increased target motor speed or a decreased target motor speed. In response to determining that the target motor speed 306c has changed, the processor may update the target motor speed 306c to the increased target motor speed or the decreased target motor speed.

Referring to FIG. 7, in particular implementations of the apparatus 100, the plurality of spin options 304 may include a shuffle clockwise spin option 304c corresponding to a shuffle clockwise spin program. In operation 700, while the processor 300 executes the shuffle clockwise spin program, the platter 106 may be cyclically spun and stopped in the clockwise direction 218. The plurality of spin options 304 may include a shuffle counterclockwise spin option 304d corresponding to a shuffle counterclockwise spin program. In operation 800, while the processor 300 executes the shuffle counterclockwise spin program, the platter 106 may be cyclically spun and stopped in the counterclockwise direction 220. In some implementations of the apparatus 100, the amount the platter 106 rotates between being stopped may be incrementally adjustable at the user interface 108, by way of, for example, adjusting the rotation parameter 306b. The amount of time the platter 106 is stopped between spins may be adjustable at the user interface 108, by way of, for example, adjusting the rest time parameter 306a.

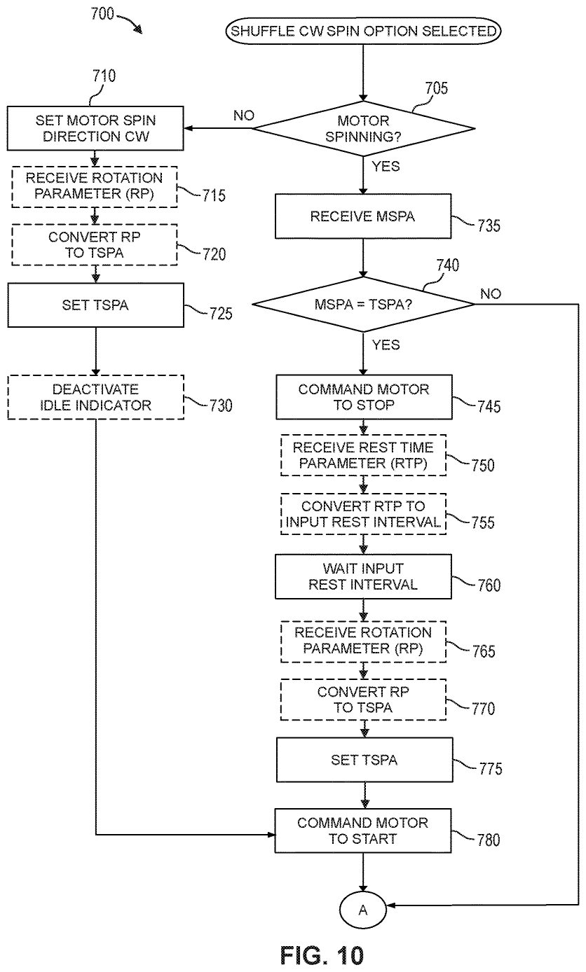

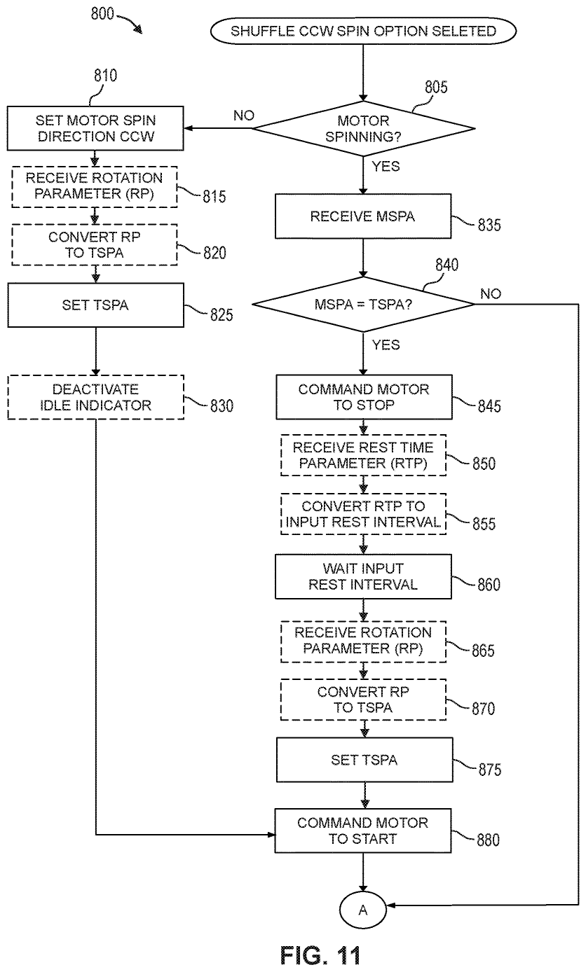

Referring to FIGS. 10 and 11, in certain implementations of the apparatus 100, executing the shuffle clockwise spin program (e.g., operation 700) or executing the shuffle counterclockwise spin program (e.g., operation 800) may include the processor 300 determining if the stepper motor 104 is spinning or not spinning (e.g., operation 705, e.g., operation 805). If the stepper motor 104 is not spinning, this may be because of, for example, the processor 300 running the corresponding spin program through its first cycle. If the stepper motor 104 is spinning, this may be because of, for example, the corresponding spin option 304 being continuously selected, and the processor 300 is cycling through the corresponding spin program.

In response to determining that the stepper motor 104 is not spinning in operation 705 or operation 805, the processor 300 may set a motor spin direction (e.g., operation 710, e.g., operation 810). When executing the shuffle clockwise spin program (e.g., operation 700), the processor 300 may set the motor spin direction to the clockwise direction 218 (e.g., operation 710). When executing the shuffle counterclockwise spin program (e.g., operation 800), the processor 300 may set the motor spin direction to the counterclockwise direction 220 (e.g., operation 810). In operation 725 and operation 825, the processor may set a target step number per motor activation (TSPA). The TSPA may be the number of steps the stepper motor 104 rotates in between being commanded to start spinning and being commanded to stop spinning. In operation 780 and operation 880, the processor 300 may command the stepper motor 104 to start spinning in the motor spin direction.

In response to determining that the stepper motor 104 is spinning in operation 705 or operation 805, the processor 300 may receive a measured step number per motor activation (MSPA) of the stepper motor 104 (e.g., operation 735, e.g., operation 835). Upon the MSPA reaching the TSPA (e.g., operation 740, e.g., operation 840), the processor 300 may command the stepper motor 104 to stop spinning (e.g., operation 745, e.g., operation 845). Upon the stepper motor 104 being stopped, the processor may wait an input rest interval (e.g., operation 760, e.g., operation 860). In operation 775 or operation 885, the processor may set the TSPA. Upon conclusion of the input rest interval, the processor may command the stepper motor 104 to start spinning (e.g., operation 780) in the motor spin direction.

Referring to FIG. 7, in particular implementations of the apparatus 100, the plurality of spin options 304 may include a jitter spin option 304e corresponding to a jitter spin program. In operation 900, while the processor 300 executes the jitter spin program, the platter 106 may be alternatingly spun in the clockwise direction 218 and the counterclockwise direction 220. In some implementations of the apparatus 100, the amount the platter 106 rotates, between the motor spin direction being reversed, may be incrementally adjustable at the user interface 108, by way of, for example, adjusting the rotation parameter 306b. The amount of time the platter 106 is stopped between spins may be adjustable at the user interface 108, by way of, for example, adjusting the rest time parameter 306a.

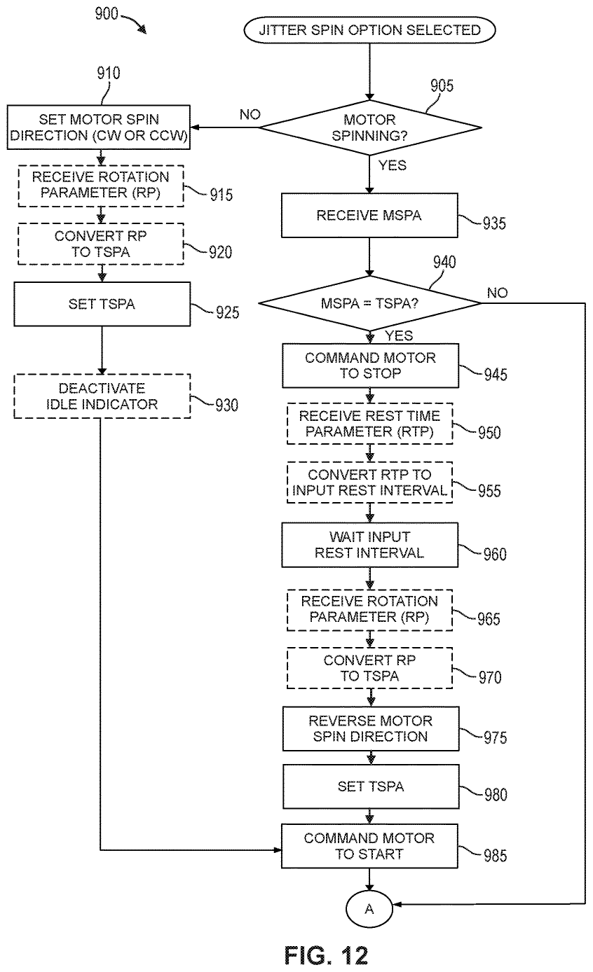

Referring to FIG. 12, in certain implementations of the apparatus 100, executing the jitter spin program (e.g., operation 900) includes the processor 300 determining if the stepper motor 104 is spinning or not spinning (operation 905). If the stepper motor 104 is not spinning, this may be because of, for example, the processor 300 running the jitter spin program through its first cycle. If the stepper motor 104 is spinning, this may be because of, for example, the jitter spin option being continuously selected, and the processor 300 is cycling through the jitter spin program.

In response to determining that the stepper motor 104 is not spinning in operation 905, the processor may set a motor spin direction (e.g., operation 910). In some implementations of the apparatus 100, the motor spin direction may be set to the clockwise direction 218. In other implementations of the apparatus 100, the motor spin direction may be set to the counterclockwise direction 220. In some other implementations of the apparatus 100, the motor spin direction may be changeable via the user interface 108. In operation 925, the processor may set a target step number per motor activation (TSPA). In operation 985, the processor may command the stepper motor 104 to start spinning in the motor spin direction.

In response to determining that the stepper motor 104 is spinning in operation 905, the processor may receive a measured step number per motor activation (MSPA) of the stepper motor 104 (e.g., operation 935). Upon the MSPA reaching the TSPA (e.g., operation 940), the processor may command the stepper motor 104 to stop spinning (e.g., operation 945). Upon the stepper motor 104 being stopped, the processor 300 may wait an input rest interval (e.g., operation 960). In operation 975, the processor 300 may reverse the motor spin direction, for example, from the clockwise direction 218 to the counterclockwise direction 220, or, for example, from the counterclockwise direction 220 to the clockwise direction 218. In operation 980, the processor may set the TSPA. Upon conclusion of the input rest interval, the processor 300 may command the stepper motor 104 to start spinning in the reversed motor spin direction (e.g., operation 985).

Referring to FIGS. 10-12, in some implementations of the apparatus 100, prior to setting the TSPA (e.g., operation 725, e.g., operation 775, e.g., operation 825, e.g., operation 875, e.g., operation 925, e.g., operation 980), the processor may receive a rotation parameter from the user interface 108 (e.g., operation 715, e.g., operation 765, e.g., operation 815, e.g., operation 865, e.g., operation 915, e.g., operation 965) and convert the rotation parameter to the TSPA (e.g., operation 720, e.g., operation 770, e.g., operation 820, e.g., operation 870, e.g., operation 920, e.g., operation 970). This may facilitate, for example, the TSPA to be adjusted mid cycle of executing the spin program. For example, in some implementations of the apparatus 100, a user may adjust the rotation parameter 306b mid cycle, by way of, for example, the platter rotation knob 128a. The processor may receive the rotation parameter 306b, a voltage reading for example, from the user interface 108, and convert the rotation parameter 306b from volts to steps, as the new TSPA. The steps of the TSPA may correspond to, for example, between a quarter rotation to a full rotation of the platter, set by the user.

In some implementations of the apparatus 100, prior to waiting the input rest interval (e.g., operation 760, e.g., operation 860, e.g., operation 960), the processor may receive a rest time parameter from the user interface 108 (e.g., operation 750, e.g., operation 850, e.g., operation 950) and convert the rest time parameter to the input rest interval (e.g., operation 755, e.g., operation 855, e.g., operation 955). This may facilitate, for example, the input rest time to be adjusted mid cycle of executing the spin program. For example, in some implementations of the apparatus 100, a user may adjust the rest time parameter 306a mid cycle, by way of, for example, the rest time knob 128b. The processor may receive the rest time parameter 306a, a voltage reading for example, from the user interface 108, and convert the rest time parameter 306a from volts to milliseconds, as the new input rest time. The milliseconds of the input rest time may correspond to, for example, between a quarter of a second and a second, set by the user.

Referring to FIGS. 7-12, in particular implementations of the apparatus 100, the processor 300 may activate an idle indicator 132 if the stepper motor 104 is stopped (e.g., operation 425). The processor 300 may deactivate the idle indicator 132 if the stepper motor 104 is spinning (e.g., operation 520, e.g., operation 620, etc.). In certain implementations of the apparatus 100, the processor 300 may determine if the stepper motor is spinning or not spinning by way of, for example, a sensor. Other implementations of the apparatus 100 may not include a sensor for detecting if the stepper motor 104 is spinning or not spinning, and instead the processor 300 may operationally activate the idle indicator immediately before or immediately after commanding the stepper motor to stop spinning, and the processor 300 may operationally deactivate the idle indicator immediately before or after commanding the stepper motor to start spinning. The idle indicator 132 may be an LED light disposed on the user interface 108.

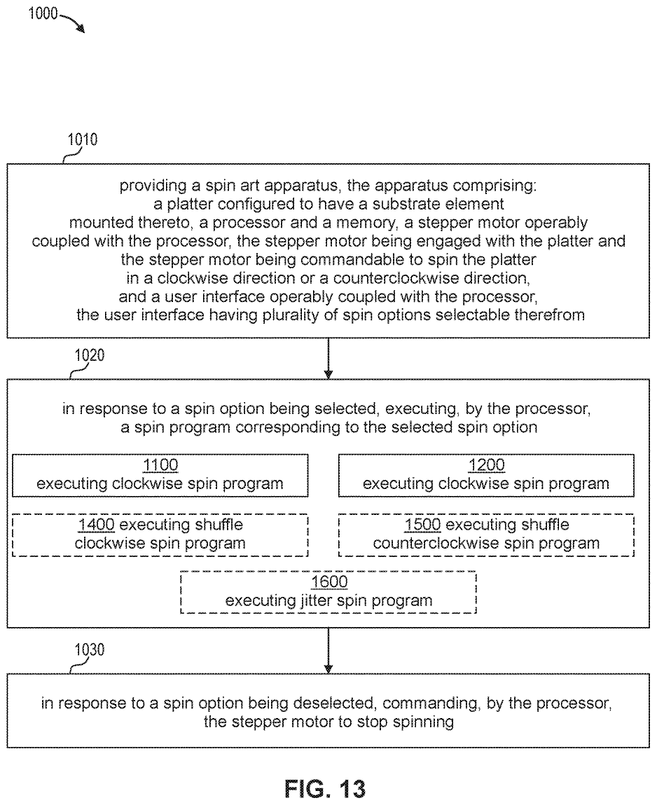

Referring to FIG. 13, particular implementations of a method for creating spin art 1000 may comprise providing a spin art apparatus 100 (step 1010). The apparatus 100 may comprise a platter 106 configured to have a substrate element 154 mounted thereto, a processor 300 and a memory 302, a stepper motor 104 operably coupled with the processor 300, the stepper motor 104 being engaged with the platter 106 and the stepper motor 104 being commandable to spin the platter 106 in a clockwise direction 218 or a counterclockwise direction 220, and a user interface 108 operably coupled with the processor 300, the user interface having a plurality of spin options 304 selectable therefrom. The method 1000 may comprise executing, by the processor 300, a spin program which corresponds to the selected spin option 304 (e.g., step 1020). The method 1000 may comprise in response to the spin option being deselected, commanding, by the processor 300, the stepper motor 104 to stop spinning (e.g., step 1030).

In some implementations of the method 1000, the plurality of spin options 304 may include a clockwise spin option 304a corresponding to a clockwise spin program, wherein while the processor 300 executes the clockwise spin program (e.g., step 1100), the platter 106 is continuously spun in the clockwise direction 218.

In some implementations of the method 1000, the plurality of spin options 304 may include a counterclockwise spin option 304b corresponding to a counterclockwise spin program, wherein while the processor 300 executes the counterclockwise spin program (e.g., step 1200), the platter 106 is continuously spun in the counterclockwise direction 220.

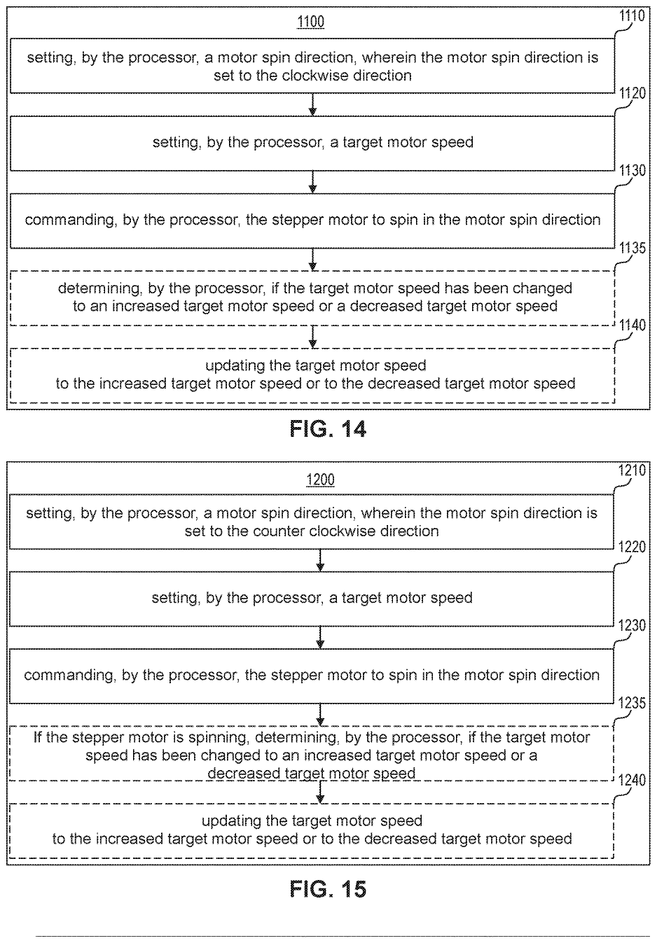

Referring to FIGS. 14 and 15, in certain implementations of the method 1000, executing the clockwise spin program (e.g., step 1100) or the counterclockwise spin program (e.g., step 1200) may include a plurality of steps (e.g., step 1110-step 1140, e.g., step 1210-step 1240). In step 1110 and 1210, the processor 300 may set a motor spin direction. For the clockwise spin program, the motor spin direction may be set to the clockwise direction 218. For the counterclockwise spin program, the motor spin direction may be set to the counterclockwise direction 220. In step 1120 and step 1220, the processor 300 may set a target motor speed. In step 1130 and step 1230, the processor 300 may command the stepper motor 104 to spin in the motor spin direction.

In particular implementations of the method 1000, the target motor speed 306c may be user-selectable and user-modifiable (e.g., by way of the parameter adjustment knobs 128a) such that the target motor speed 306c can be adjusted up and/or down during the course of the execution of the program. The target motor speed 306c may change during execution of a spin program (e.g., step 1100, e.g., step 1200), for example, by way of a user adjusting the target motor speed 306c at the user interface 108 while the respective spin program is executing. In step 1135 and step 1235, if the stepper motor 104 is spinning, the processor may determine if the target motor speed 306c has been changed to an increased target motor speed or a decreased target motor speed. In step 1140 and step 1240, in response to determining that the target motor speed 306c has been changed, the processor may update the target motor speed 306c to the increased target motor speed or the decreased target motor speed.

Referring to FIG. 13, in some implementations of the method 1000, the plurality of spin options 304 may include a shuffle clockwise spin option 304c corresponding to a shuffle clockwise spin program, wherein while the processor 300 executes the shuffle clockwise spin program (e.g., step 1400), the platter 106 is cyclically spun and stopped in the clockwise direction 218.

In some implementations of the method 1000, the plurality of spin options 304 may include a shuffle counterclockwise spin option 304d corresponding to a shuffle counterclockwise spin program, wherein while the processor 300 executes the shuffle counterclockwise spin program (e.g., step 1500), the platter 106 is cyclically spun and stopped in the counterclockwise direction 220.

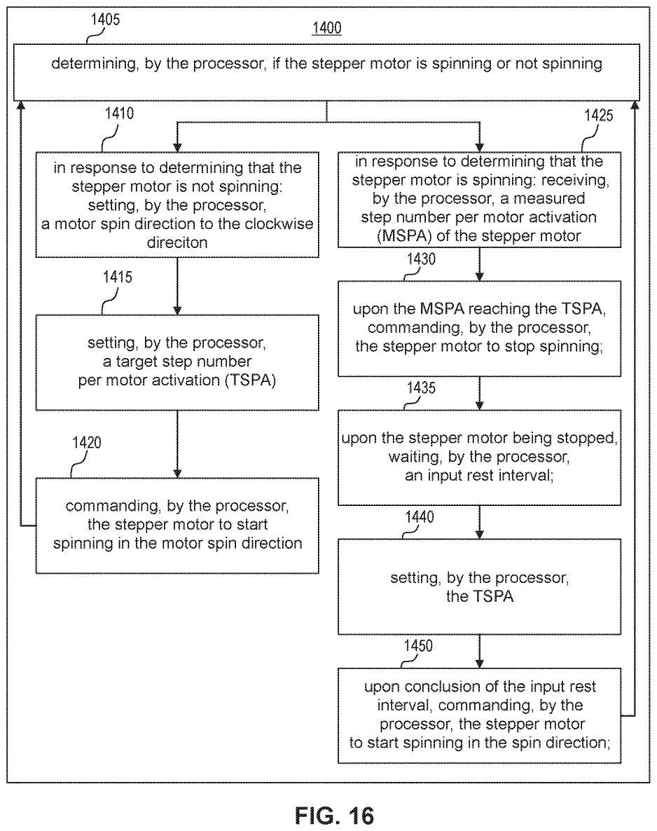

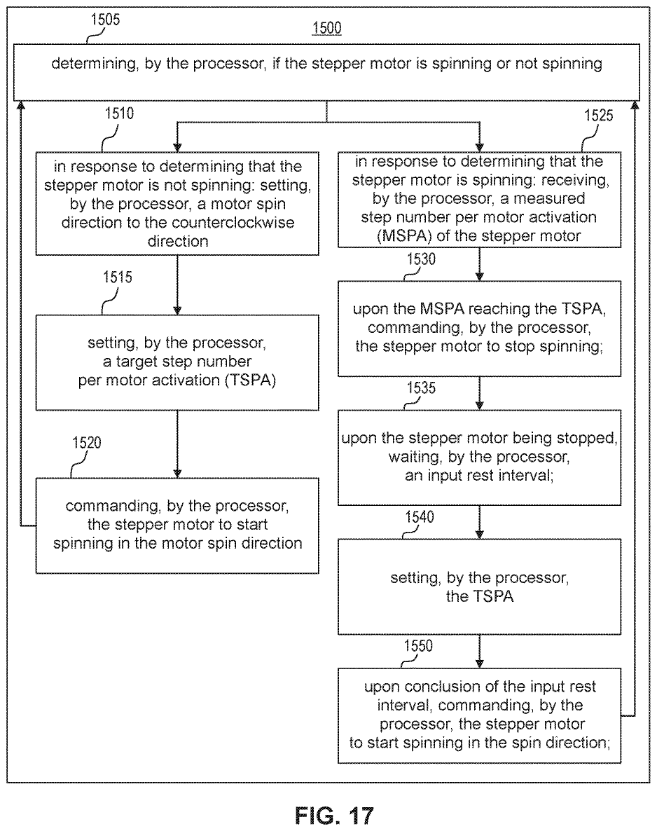

Referring to FIGS. 16 and 17, in particular implementations of the method 1000, executing the shuffle clockwise spin program (e.g., step 1400) or the shuffle counterclockwise spin program (e.g., step 1500) may include a plurality of steps (e.g., step 1405-step 1450, e.g., step 1505-step 1550). In step 1405 and step 1505, the processor 300 may determine if the stepper motor 104 is spinning or not spinning. If the stepper motor 104 is not spinning, this may be because of, for example, the processor 300 running the corresponding spin program through its first cycle. If the stepper motor 104 is spinning, this may be because of, for example, the corresponding spin option being continually selected, and the processor 300 is cycling through the corresponding spin program.

In response to determining that the stepper motor 104 is not spinning, the processor 300 may set a motor spin direction (e.g., step 1410, e.g., step 1510). For the shuffle clockwise spin program, the motor spin direction may be set to the clockwise direction 218. For the shuffle counterclockwise spin program, the motor spin direction may be set to the counterclockwise direction 220. In step 1415 and step 1515, the processor 300 may set a target step number per motor activation (TSPA). In step 1420 and step 1520, the processor 300 may command the stepper motor 104 to start spinning in the motor spin direction.

In response to determining that the stepper motor 104 is spinning, the processor 300 may receive a measured step number per motor activation (MSPA) of the stepper motor 104 (e.g., step 1425, e.g., step 1525). Upon the MSPA reaching the TSPA, the processor 300 may command the stepper motor 104 to stop spinning (e.g., step 1430, e.g., step 1530). Upon the stepper motor 104 being stopped, the processor 300 may wait an input rest interval (e.g., step 1435, e.g., step 1535). In step 1440 and step 1540, the processor 300 may set the TSPA. Upon conclusion of the input rest interval, the processor 300 may command the stepper motor 104 to start spinning in the motor spin direction (e.g., step 1450, e.g., 1550).

Referring to FIG. 13, in some implementations of the method 1000, the plurality of spin options 304 may include a jitter spin option 304e corresponding to a jitter spin program, wherein while the processor 300 executes the jitter spin program (e.g., step 1600), the platter 106 may be alternatingly spun in the clockwise direction 218 and the counterclockwise direction 220.

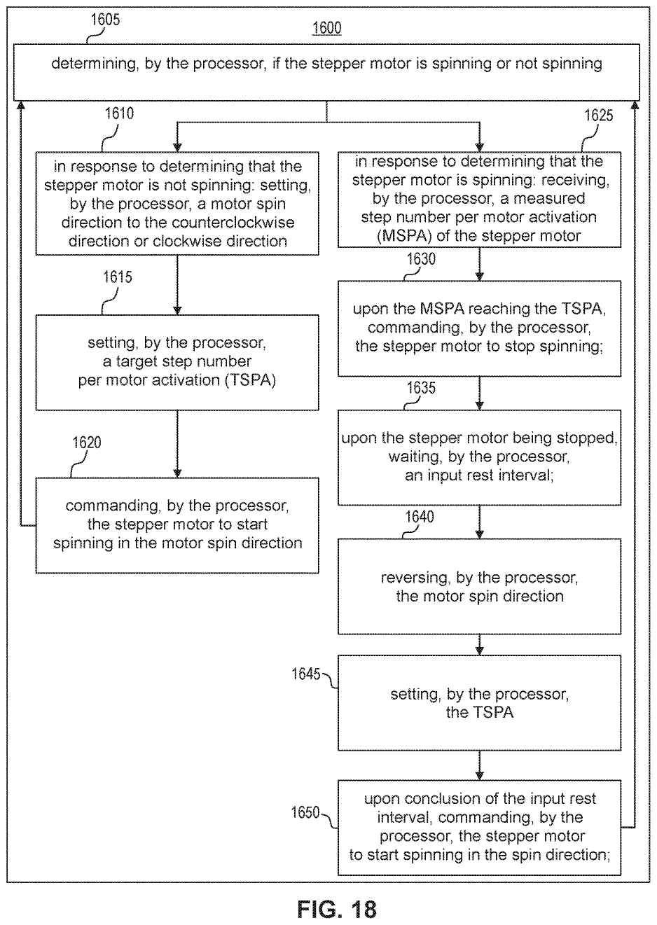

Referring to FIG. 18, in certain implementations of the method 1000, executing the jitter spin program (e.g., step 1600) may include a plurality of steps (e.g., step 1605-step 1650). In step 1605, the processor 300 may determine if the stepper motor 104 is spinning or not spinning. If the stepper motor 104 is not spinning, this may be because of, for example, the processor running the jitter spin program through its first cycle. If the stepper motor 104 is spinning, this may be because of, for example, the jitter spin option being continually selected, and the processor 300 is cycling through the jitter spin program.

In response to determining that the stepper motor 104 is not spinning, the processor 300 may set a motor spin direction (e.g., step 1610). In some implementations of the method 1000, the motor spin direction may be set to the clockwise direction 218. In other implementations of the method 1000, the motor spin direction may be set to the counterclockwise direction 220. In some other implementations of the method 1000, the motor spin direction may be changeable via the user interface 108. In step 1615, the processor 300 may set a target step number per motor activation (TSPA). In step 1620, the processor 300 may command the stepper motor 104 to start spinning in the motor spin direction.

In response to determining that the stepper motor 104 is spinning, the processor 300 may receive a measured step number per motor activation (MSPA) of the stepper motor 104 (e.g., step 1625). Upon the MSPA reaching the TSPA, the processor 300 may command the stepper motor 104 to stop spinning (e.g., step 1630). Upon the stepper motor 104 being stopped, the processor 300 may wait an input rest interval (e.g., step 1635). In step 1640, the processor 300 may reverse the motor spin direction. In step 1645, the processor 300 may set the TSPA. Upon conclusion of the input rest interval, the processor 300 may command the stepper motor 104 to start spinning in the motor spin direction (e.g., step 1650).

The program operations may be stored in a memory which may be implemented in a computing device using a standard memory device, such as, for example, a random access memory (RAM). The program operations may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example implementations of the present disclosure.

The following describes a particular implementation of the apparatus 100 and method 1000 and should not be taken to limit the scope of the invention to the following elements and functions described below.

### Unit Overview

The unit may be designed to be used to create a variation of “spin-art” designs. It may be comprised of a stepper motor screwed to a stabilizing motor mount beam which itself may be part of the invention enclosure. A light-weight platter may be attached to a flange and held in place on the flange by screws in the platter mounting holes. The flange may be mounted on the stepper motor spindle such that when the motor rotates, the platter may also.

### Unit Operation

Plugging the unit into a 120V power source may cause the unit to power up. Once it is ready for operation the idle LED may illuminate indicating that the unit is in a rest state and ready for operation.

The operator may affix the medium to which their design may be applied (a sheet of paper, paper board, acrylic) to the platter. They then may select the pigment that they wish to apply to the medium for their design, be it in a bottle or tube. The operator may then select which program they wish the unit to perform by depressing one of the program buttons on the Control button panel. The operator may apply the pigment to the medium on the platter either before or while the unit is performing the desired program.

Program operation details

The Clockwise Spin program button may trigger the microcontroller to activate the stepper controller to spin the motor connected to the platter, in a continuous clockwise direction for as long as the clockwise spin program button is depressed. The microcontroller may accelerate the stepper motor, via the stepper controller, up to a preprogrammed maximum rotational speed. The stepper motor may continue to rotate clockwise at that speed until the operator releases the clockwise spin program button. The operator may apply pigment to the medium on the spinning platter. By releasing the clockwise spin program button, the microcontroller may decelerate the velocity of the motor, via the stepper controller, to a complete stop. The microcontroller may then illuminate the idle LED which may indicate that the unit is at rest.

The Counterclockwise Spin program button may trigger the microcontroller to activate the stepper controller to spin the motor connected to the platter, in a continuous counterclockwise direction for as long as the counterclockwise spin program button is depressed. The microcontroller may accelerate the stepper motor, via the stepper controller, up to a pre-programmed maximum rotational speed. The stepper motor may continue to rotate counterclockwise at that speed until the operator releases the counterclockwise spin program button. The operator may apply pigment to the medium on the spinning platter. By releasing the counterclockwise spin program button, the microcontroller may decelerate the velocity of the motor, via the stepper controller, to a complete stop. The microcontroller may then illuminate the idle LED which may indicate that the unit is at rest.

The Clockwise Stutter program button may trigger the microcontroller to activate the stepper controller to spin the motor connected to the platter, in an infinite series of repeating clockwise rotations interspersed with rest periods, the amount of rotation and rest for an individual stutter motion being dynamically controlled by the operator using two rotating knobs and located on the control button panel. To execute a single stutter motion, the microcontroller may begin to accelerate the stepper motor, via the stepper controller, up to a pre-programmed maximum rotational speed in a clockwise direction. The microcontroller may read the voltage coming through the Rotation amount selector knob and translates the voltage into a number representing the maximum number of steps to rotate the motor for a single stutter. As the motor rotates, the microcontroller may monitor how many steps the motor has rotated. Upon the motor rotating the calculated maximum number of steps for a single stutter, the microcontroller may trigger the stepper motor, via the stepper controller to immediately stop. The microcontroller may then read the voltage coming through the Rest amount selector knob and translate the voltage into a number representing the number of milliseconds to keep the motor in a stopped state before beginning another stutter motion. The microcontroller may then rest for the calculated number of milliseconds. After the calculated number of milliseconds have passed, the microcontroller may begin another stutter motion. It may continue to execute stutter motions indefinitely until the clockwise stutter program button is released.

The Counterclockwise Stutter program button may trigger the microcontroller to activate the stepper controller to spin the motor connected to the platter, in an infinite series of repeating counterclockwise rotations interspersed with rest periods, the amount of rotation and rest for an individual stutter motion being dynamically controlled by the operator using two rotating knobs and located on the control button panel. To execute a single stutter motion, the microcontroller may begin to accelerate the stepper motor, via the stepper controller, up to a pre-programmed maximum rotational speed in a counterclockwise direction. The microcontroller may read the voltage coming through the Rotation amount selector knob and translate the voltage into a number representing the maximum number of steps to rotate the motor for a single stutter. As the motor rotates, the microcontroller may monitor how many steps the motor has rotated. Upon the motor rotating the calculated maximum number of steps for a single stutter, the microcontroller may trigger the stepper motor, via the stepper controller to immediately stop. The microcontroller may then read the voltage coming through the Rest amount selector knob and translate the voltage into a number representing the number of milliseconds to keep the motor in a stopped state before beginning another stutter motion. The microcontroller may then rest for the calculated number of milliseconds. After the calculated number of milliseconds have passed, the microcontroller may begin another stutter motion. It may continue to execute stutter motions indefinitely until the counterclockwise stutter program button is released.

The Jitter program button may trigger the microcontroller to activate the stepper controller to spin the motor connected to the platter, in an infinite series of repeating, alternating clockwise then counterclockwise rotations interspersed with rest periods, the amount of rotation and rest for an individual jitter motion being dynamically controlled by the operator using two rotating knobs and located on the control button panel. To execute the clockwise part of a single jitter motion, the microcontroller may begin to accelerate the stepper motor, via the stepper controller, up to a pre-programmed maximum rotational speed in a clockwise direction. The microcontroller may read the voltage coming through the Rotation amount selector knob and translates the voltage into a number representing the maximum number of steps to rotate the motor for a single jitter part. As the motor rotates, the microcontroller may monitor how many steps the motor has rotated. Upon the motor rotating the calculated maximum number of steps for a single jitter part, the microcontroller may trigger the stepper motor, via the stepper controller to immediately stop. The microcontroller may then read the voltage coming through the Rest amount selector knob and translate the voltage into a number representing the number of milliseconds to keep the motor in a stopped state before beginning the counterclockwise part of a single jitter motion. The microcontroller may then rest for the calculated number of milliseconds. After the calculated number of milliseconds have passed, the microcontroller may execute the counterclockwise part of a single jitter motion. It may begin to accelerate the stepper motor, via the stepper controller, up to a pre-programmed maximum rotational speed in a counterclockwise direction. The microcontroller may read the voltage coming through the Rotation amount selector knob and translate the voltage into a number representing the maximum number of steps to rotate the motor for a single jitter part. As the motor rotates, the microcontroller may monitor how many steps the motor has rotated. Upon the motor rotating the calculated maximum number of steps for a single jitter part, the microcontroller may trigger the stepper motor, via the stepper controller to immediately stop. The microcontroller may then read the voltage coming through the Rest amount selector knob and translate the voltage into a number representing the number of milliseconds to keep the motor in a stopped state before beginning another jitter motion. The microcontroller may then rest for the calculated number of milliseconds. After the calculated number of milliseconds have passed, the microcontroller may begin another jitter motion. It may continue to execute jitter motions indefinitely until the jitter program button is released.

Within this disclosure, different entities (which may variously be referred to as “elements,” “members,” “assemblies,” other components, etc.) may be described or claimed as “configured” to perform one or more tasks or operations. This formulation [entity] configured to [perform one or more tasks]—is used herein to refer to structure (i.e., something physical, such as a detent). More specifically, this formulation is used to indicate that this structure is arranged to perform the one or more tasks during operation. A structure can be said to be “configured to” perform some task even if the structure is not currently being operated. A “thrust bearing configured to facilitate an axial force transfer” is intended to cover, for example, a thrust bearing that has force transfer members which facilitate this axial force transfer during operation, even if the bearing in question is not currently being used (e.g., no load is currently being applied). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function and may be “configured to” perform the function after programming.

The following listing matches certain terminology used within this disclosure with corresponding reference numbers used in the non-limiting implementations illustrated in the several FIG.
100 spin art apparatus (i.e., apparatus for creating spin art, i.e., apparatus, e.g., unit)
102 microcontroller (e.g., comprising processor and memory)
104 stepper motor (e.g., motor)
106 platter (e.g., light-weight platter)
108 user interface (e.g., control button panel)
110 main housing
114 main compartment
116 secondary compartment
118 motor mounting beam (e.g., stabilizing motor mount beam)
120 power supply (e.g., 120V)
122 stepper motor controller
126 program button
126a counterclockwise spin button
126b shuffle counterclockwise spin button (e.g., stutter counterclockwise spin button)
126c jitter spin button
126d clockwise spin button
126e shuffle clockwise spin button (e.g., stutter clockwise spin button)
128 parameter adjustment knob (e.g., rotating knob)
128a platter rotation knob (e.g., to adjust rotation parameter, e.g., rotation amount selector knob)
128b rest time knob (e.g., to adjust rest time parameter, e.g., rest amount selector knob)
132 idle indicator (e.g., idle LED)
134 user interface communication element (e.g., ribbon cable, e.g., wireless connection, e.g., bluetooth)
136 spin connector element (e.g., flange)
138 platter mounting aperture (of platter, e.g., platter mounting holes)
140 motor mounting aperture (of motor mounting portion)
141 shaft receiving aperture
142 compartment dividing wall
144 main wiring aperture (of enclosure dividing wall)
146 main housing secondary wall
148 stepper motor wiring
150 stepper motor shaft
152 connector mounting apertures (of spin connector element)
154 substrate element (e.g., medium, e.g., sheet of paper, e.g., paper board; e.g., acrylic, etc., e.g., cardboard, e.g., metal, e.g., plastic, e.g., fabric, etc.)
156 pigment (e.g., from bottle, e.g., from tube, e.g., liquid pigment, e.g., liquid acrylic, e.g., house paint)
158 tablet
200 motor mounting portion (e.g., of motor mounting beam)
202 upper surface (of motor mounting beam)
204 lower surface (of motor mounting beam)
214 inboard surface (of main housing, e.g., of a pair of oppositely disposed inboard surfaces)
216 spin axis
218 clockwise direction
220 counterclockwise direction
300 processor (e.g., of microcontroller, e.g., CPU)
302 memory (e.g., of microcontroller)
304 spin option (e.g., clockwise spin option, e.g., counterclockwise spin option, etc.)
304a clockwise spin option
304b counterclockwise spin option
304c shuffle clockwise spin option
304d shuffle counterclockwise spin option
304e jitter spin option
306 adjustable parameters (e.g., rest time parameter, e.g., rotation parameter, e.g., target motor speed)
306a rest time parameter (e.g., adjustable between 0.1 seconds and 1 second, e.g., adjustable between 0.25 seconds and 1 second, e.g., adjustable between 0.25 seconds and 0.5 seconds)
306b rotation parameter (e.g., adjustable between 0.1 rotation and a full rotation e.g., adjustable between 0.25 rotation and a full rotation, e.g., adjustable between 0.25 rotation and a 0.5 rotation)
306c target motor speed
400 main operations
405 determine if a spin option is selected
410 execute a spin program (e.g., execute clockwise spin program, execute counterclockwise spin program, etc.)
415 determine if the motor is spinning
420 command the motor to stop spinning
425 activate idle indicator
500 execute clockwise spin program
505 determine if the motor is spinning
510 set motor spin direction to the clockwise direction
515 set the target motor speed
520 deactivate the idle indicator
525 command the motor to start spinning
600 execute counterclockwise spin program
605 determine if the motor is spinning
610 set motor spin direction to the counterclockwise direction
615 set the target motor speed
620 deactivate the idle indicator
625 command the motor to start spinning
700 execute shuffle clockwise spin program
705 determine if the motor is spinning
710 set the motor spin direction to the clockwise direction
715 receive rotation parameter
720 convert rotation parameter to target step number per motor activation
725 set the target step number per motor activation
730 deactivate the idle indicator
735 receive a measured step number per motor activation
740 determine if the measured step number per motor activation equals the target step number per motor activation
745 command the motor to stop spinning
750 receive a rest time parameter
755 convert the rest time parameter to an input rest interval
760 wait the input rest interval
765 receive rotation parameter
770 convert rotation parameter to target step number per motor activation
775 set the target step number per motor activation
780 command the motor to start spinning
800 execute shuffle counterclockwise spin program
805 determine if the motor is spinning
810 set the motor spin direction to the counterclockwise direction
815 receive rotation parameter
820 convert rotation parameter to target step number per motor activation
825 set the target step number per motor activation
830 deactivate the idle indicator
835 receive a measured step number per motor activation
840 determine if the measured step number per motor activation equals the target step number per motor activation
845 command the motor to stop spinning
850 receive a rest time parameter
855 convert the rest time parameter to an input rest interval
860 wait the input rest interval
865 receive rotation parameter
870 convert rotation parameter to target step number per motor activation
875 set the target step number per motor activation
880 command the motor to start spinning
900 execute jitter spin program
905 determine if the motor is spinning
910 set the motor spin direction to the clockwise direction
915 receive rotation parameter
920 convert rotation parameter to target step number per motor activation
925 set the target step number per motor activation
930 deactivate the idle indicator
935 receive a measured step number per motor activation
940 determine if the measured step number per motor activation equals the target step number per motor activation
945 command the motor to stop spinning
950 receive a rest time parameter
955 convert the rest time parameter to an input rest interval
960 wait the input rest interval
965 receive rotation parameter
970 convert rotation parameter to target step number per motor activation
975 reverse the motor spin direction
980 set the target step number per motor activation
985 command the motor to start spinning
1000 method for creating spin art (e.g., comprising a plurality of steps, e.g., step 1010, e.g., step 1020, etc.)
1010 step of providing a spin art apparatus
1020 step of executing a spin program (e.g., step 1100, e.g., step 1200, etc.)
1030 step of commanding the motor to stop spinning
1100 step of executing clockwise spin program
1200 step of executing counterclockwise spin program
1400 step of executing shuffle clockwise spin program
1500 step of executing shuffle counterclockwise spin program
1600 step of executing jitter spin program While implementations of the invention have been illustrated and described, it is not intended that these implementations illustrate and describe all possible forms of the invention. Rather, the words used in the specification are words of description rather than limitation, and it is understood that various changes may be made without departing from the spirit and scope of the invention.

What is claimed is:

1. An apparatus for creating spin art, the apparatus comprising:
a platter configured to have a substrate element mounted thereon;
a processor;
a stepper motor operably coupled with the processor, wherein
the stepper motor is engaged with the platter; and
the stepper motor is commandable to spin the platter in a clockwise direction about a spin axis or a counterclockwise direction about the spin axis;
a motor mounting portion with the stepper motor affixed thereto;
a user interface operably coupled with the processor, the user interface having a plurality of spin options selectable and deselectable therefrom; and
a memory communicatively connected to the processor, the memory containing instructions that when executed by the processor cause the processor to perform a plurality of operations comprising:
in response to a said spin option being selected:
executing a spin program which corresponds to the selected spin option; and
in response to the spin option being deselected:
commanding the stepper motor to stop spinning;
wherein the plurality of spin options include
a clockwise spin option corresponding to a clockwise spin program, wherein while the processor executes the clockwise spin program, the platter is continuously spun in the clockwise direction; and
a counterclockwise spin option corresponding to a counterclockwise spin program, wherein while the processor executes the counterclockwise spin program, the platter is continuously spun in the counterclockwise direction.

2. The apparatus of claim 1, wherein the operations performed by the processor further comprise
activating an idle indicator if the stepper motor is stopped.

3. The apparatus of claim 1, wherein
the apparatus comprises a main housing;
a main compartment is defined within the main housing; and
the stepper motor, the motor mounting portion, and the platter are each disposed in the main compartment.

4. The apparatus of claim 3, wherein
the apparatus comprises a motor mounting beam;
the motor mounting beam is affixed to a pair of oppositely disposed inboard surfaces of the main housing; and
the motor mounting portion is disposed on the motor mounting beam.

5. The apparatus of claim 4, wherein
the stepper motor is mounted to a lower surface of the motor mounting beam;
the platter is disposed above an upper surface of the motor mounting beam; and
the engagement of the platter with the stepper motor is facilitated by a spin connector element extending through the motor mounting beam.

6. The apparatus of claim 3, wherein
a secondary compartment is defined within the main housing;
a compartment dividing wall separates the main compartment from the secondary compartment; and
the processor and memory are disposed in the secondary compartment.

7. The apparatus of claim 3, wherein the user interface is affixed to the main housing.

8. The apparatus of claim 1, wherein
the user interface comprises a plurality of program buttons;
for each of the plurality of program buttons
a said spin option corresponds thereto;
while the program button is depressed, the corresponding spin option is selected; and
when the program button is released, the corresponding spin option is deselected.

9. The apparatus of claim 1, wherein the user interface is configured to communicate with the processor via a wireless connection.

10. The apparatus of claim 1, wherein executing the clockwise spin program or the counterclockwise spin program includes the operations of:
setting a motor spin direction;
setting a target motor speed; and
commanding the stepper motor to start spinning in the motor spin direction;
wherein
for the clockwise spin program, the motor spin direction is set to the clockwise direction; and
for the counterclockwise spin program, the motor spin direction is set to the counterclockwise direction.

11. The apparatus of claim 10, wherein executing the clockwise spin program or the counterclockwise spin program includes the operations of:
determining if the stepper motor is spinning or not spinning;
in response to determining that the stepper motor is spinning, determining if the target motor speed has been changed to an increased target motor speed or a decreased target motor speed; and
in response to determining that the target motor speed has been changed, updating the target motor speed to the increased target motor speed or to the decreased target motor speed.

12. The apparatus of claim 10, wherein the plurality of operations to be performed by the processor further comprise
activating an idle indicator if the stepper motor is stopped; and
deactivating an idle indicator if the stepper motor is spinning.

13. The apparatus of claim 12, wherein the idle indicator is an LED light disposed on the user interface.

14. The apparatus of claim 1, wherein the plurality of spin options includes
a shuffle clockwise spin option corresponding to a shuffle clockwise spin program, wherein while the processor executes the shuffle clockwise spin program, the platter is cyclically spun and stopped in the clockwise direction; and
a shuffle counterclockwise spin option corresponding to a shuffle counterclockwise spin program, wherein while the processor executes the shuffle counterclockwise spin program, the platter is cyclically spun and stopped in the counterclockwise direction.

15. The apparatus of claim 14, wherein executing the shuffle clockwise spin program or the shuffle counterclockwise spin program includes the operations of:
determining if the stepper motor is spinning or not spinning;
in response to determining that the stepper motor is not spinning:
setting a motor spin direction;
setting a target step number per motor activation (TSPA); and
commanding the stepper motor to start spinning in the motor spin direction; and
in response to determining that the stepper motor is spinning:
receiving a measured step number per motor activation (MSPA) of the stepper motor;
upon the MSPA reaching the TSPA, commanding the stepper motor to stop spinning;
upon the stepper motor being stopped, waiting an input rest interval;
setting the TSPA; and
upon conclusion of the input rest interval, commanding the stepper motor to start spinning in the motor spin direction;
wherein
for the shuffle clockwise spin program, the motor spin direction is set to the clockwise direction; and
for the shuffle counterclockwise spin program, the motor spin direction is set to the counterclockwise direction.

16. The apparatus of claim 15, wherein, for both the shuffle clockwise spin program and the shuffle counterclockwise spin program, the operations performed by the processor further comprise:
activating an idle indicator if the stepper motor is stopped; and
deactivating the idle indicator if the stepper motor is spinning.

17. The apparatus of claim 1, wherein the plurality of spin options includes
a jitter spin option corresponding to a jitter spin program, wherein while the processor executes the jitter spin program, the platter is alternatingly spun in the clockwise direction and the counterclockwise direction.

18. The apparatus of claim 17, wherein executing the jitter spin program includes the operations of:
determining if the stepper motor is spinning or not spinning;
in response to determining that the stepper motor is not spinning:
setting a motor spin direction;
setting a target step number per motor activation (TSPA); and
commanding the stepper motor to start spinning in the motor spin direction; and
in response to determining that the stepper motor is spinning:
receiving a measured step number per motor activation (MSPA) of the stepper motor;
upon the MSPA reaching the TSPA, commanding the stepper motor to stop spinning;
upon the stepper motor being stopped, waiting an input rest interval;
reversing the motor spin direction;
setting the TSPA; and
upon conclusion of the input rest interval, commanding the stepper motor to start spinning in the reversed motor spin direction.

19. The apparatus of claim 18, wherein the plurality of operations to be performed by the processor further comprise:
prior to setting the TSPA:
receiving a rotation parameter from the user interface; and
converting the rotation parameter to the TSPA; and
prior to waiting the input rest interval:
receiving a rest time parameter from the user interface; and
converting the rest time parameter to the input rest interval.

20. The apparatus of claim 19, wherein
the user interface comprises a rest time knob and a platter rotation knob;
the rest time knob is configured to be adjusted by a user in order to incrementally increase or decrease the rest time parameter; and
the platter rotation knob is configured to be adjusted by a user in order to incrementally increase or decrease the rotation parameter.

21. An apparatus for creating spin art, the apparatus comprising:
a platter configured to have a substrate element mounted thereon;
a processor;
a stepper motor operably coupled with the processor, wherein
the stepper motor is engaged with the platter; and
the stepper motor is commandable to spin the platter in a clockwise direction about a spin axis or a counterclockwise direction about the spin axis;
a user interface operably coupled with the processor, the user interface having a plurality of spin options selectable and deselectable therefrom;
a main housing with a main compartment defined therein, wherein the stepper motor and the platter are each disposed in the main compartment, the main compartment having a motor mounting portion with the stepper motor affixed thereto;
a memory communicatively connected to the processor, the memory containing instructions that when executed by the processor cause the processor to perform a plurality of operations comprising:
in response to a said spin option being selected:
executing a spin program which corresponds to the selected spin option; and
in response to the spin option being deselected:
commanding the stepper motor to stop spinning;
wherein the plurality of spin options include
a clockwise spin option corresponding to a clockwise spin program, wherein while the processor executes the clockwise spin program, the platter is continuously spun in the clockwise direction;
a counterclockwise spin option corresponding to a counterclockwise spin program, wherein while the processor executes the counterclockwise spin program, the platter is continuously spun in the counterclockwise direction;
a shuffle clockwise spin option corresponding to a shuffle clockwise spin program, wherein while the processor executes the shuffle clockwise spin program, the platter is cyclically spun and stopped in the clockwise direction;
a shuffle counterclockwise spin option corresponding to a shuffle counterclockwise spin program, wherein while the processor executes the shuffle counterclockwise spin program, the platter is cyclically spun and stopped in the counterclockwise direction; and
a jitter spin option corresponding to a jitter spin program, wherein while the processor executes the jitter spin program, the platter is alternatingly spun in the clockwise direction and the counterclockwise direction.

22. A method for creating spin art, the method comprising:
providing a spin art apparatus, the apparatus comprising:
a platter configured to have a substrate element mounted thereto, a processor and a memory, a stepper motor operably coupled with the processor, the stepper motor being engaged with the platter and the stepper motor being commandable to spin the platter in a clockwise direction or a counterclockwise direction, and a user interface operably coupled with the processor, the user interface having a plurality of spin options selectable therefrom;
in response to a said spin option being selected, executing, by the processor, a spin program which corresponds to the selected spin option; and
in response to the spin option being deselected, commanding, by the processor, the stepper motor to stop spinning;
wherein the plurality of spin options includes
a clockwise spin option corresponding to a clockwise spin program, wherein while the processor executes the clockwise spin program, the platter is continuously spun in the clockwise direction; and
a counterclockwise spin option corresponding to a counterclockwise spin program, wherein while the processor executes the counterclockwise spin program, the platter is continuously spun in the counterclockwise direction.

23. The method of claim 22, wherein executing the clockwise spin program or the counterclockwise spin program includes the steps of:
setting, by the processor, a motor spin direction;
setting, by the processor, a target motor speed; and
commanding, by the processor, the stepper motor to spin in the motor spin direction; wherein
for the clockwise spin program, the motor spin direction is set to the clockwise direction; and
for the counterclockwise spin program, the motor spin direction is set to the counterclockwise direction.

24. The method of claim 23, wherein the plurality of spin options includes
a shuffle clockwise spin option corresponding to a shuffle clockwise spin program, wherein while the processor executes the shuffle clockwise spin program, the platter is cyclically spun and stopped in the clockwise direction; and
a shuffle counterclockwise spin option corresponding to a shuffle counterclockwise spin program, wherein while the processor executes the shuffle counterclockwise spin program, the platter is cyclically spun and stopped in the counterclockwise direction.

25. The method of claim 24, wherein executing the shuffle clockwise spin program or the shuffle counterclockwise spin program includes the steps of:
determining, by the processor, if the stepper motor is spinning or not spinning;
in response to determining that the stepper motor is not spinning:
setting, by the processor, a motor spin direction;
setting, by the processor, a target step number per motor activation (TSPA); and
commanding, by the processor, the stepper motor to start spinning in the motor spin direction; and
in response to determining that the stepper motor is spinning:
receiving, by the processor, a measured step number per motor activation (MSPA) of the stepper motor;
upon the MSPA reaching the TSPA, commanding, by the processor, the stepper motor to stop spinning;
upon the stepper motor being stopped, waiting, by the processor, an input rest interval;
setting, by the processor, the TSPA; and
upon conclusion of the input rest interval, commanding, by the processor, the stepper motor to start spinning in the motor spin direction;
wherein
for the shuffle clockwise spin program, the motor spin direction is set to the clockwise direction; and
for the shuffle counterclockwise spin program, the motor spin direction is set to the counterclockwise direction.

26. The method of claim 23, wherein the plurality of spin options includes
a jitter spin option corresponding to a jitter spin program, wherein while the processor executes the jitter spin program, the platter is alternatingly spun in the clockwise direction and the counterclockwise direction.

27. The method of claim 26, wherein executing the jitter spin program includes the steps of:
determining, by the processor, if the stepper motor is spinning;
in response to determining that the stepper motor is not spinning:
setting, by the processor, a motor spin direction;
setting, by the processor, a target step number per motor activation (TSPA); and
commanding, by the processor, the stepper motor to start spinning in the motor spin direction; and
in response to determining that the stepper motor is spinning:
receiving, by the processor, a measured step number per motor activation (MSPA) of the stepper motor;
upon the MSPA reaching the TSPA, commanding, by the processor, the stepper motor to stop spinning;
upon the stepper motor being stopped, waiting, by the processor, an input rest interval;
reversing, by the processor, the motor spin direction;
setting, by the processor, the TSPA; and
upon conclusion of the input rest interval, commanding, by the processor, the stepper motor to start spinning in the reversed motor spin direction.
